(19) United States
(12) Patent Application Publication
(10) Pub. No.: US 2004/0212502 A1
(43) Pub. Date: Oct. 28, 2004

(54) Mail delivery alarm system with intergrated transmitter

(76) Inventor: Allan Dalgaard, Frederikssund (DK)

Correspondence Address: MERCHANT & GOULD PC, P.O. BOX 2903, MINNEAPOLIS, MN, 55402-0903, US

(21) Appl. No.: 10/480,678

(22) PCT Filed: Nov. 12, 2001
(86) PCT No.: PCT/DK01/00744

(30) Foreign Application Priority Data
Jun. 13, 2001 (DK) PA 2001 00922

(51) Int. Cl. G08B 13/14

(52) U.S. Cl. 340/569

(57) ABSTRACT

A radio-signal-based mail delivery alarm system comprising a transmitter unit provided in connection with a mailbox or mail-slot flap (2) and a receiver unit for being located at a distance from the transmitter unit and being able to receive a radio signal emitted by the transmitter unit. The transmitter unit comprises a movement sensor for detecting movement of the mailbox or mail-slot flap (2) and a transmitter with power supply and antenna (12) for emitting a radio signal in response to movement of the mailbox or mail-slot flap (2). As opposed to the prior art transmitter units for such mail delivery alarm systems, the present transmitter unit is built integrally with the mailbox or mail-slot flap (2).

The present invention relates to a radio-signal-based mail delivery alarm system comprising a transmitter unit provided in connection with a mailbox or a mail-slot flap and a receiver for being located at a distance from the transmitter unit and being able to receive a radio signal emitted by the transmitter unit, which transmitter unit comprises a movement sensor for detecting movement of the mailbox or mail-slot flap, and a transmitter unit with power supply and antenna for emitting a radio signal in response to movement of the mailbox or mail-slot flap.

A number of different radio-signal-based mail delivery alarm systems are known that comprise a transmitter unit that is mounted on a mailbox flap and that registers when the mailbox flap is opened and subsequently transmits a radio signal to a receiver unit that informs the user by means of a light or sound signal that something was delivered to the mailbox.

One example is shown in U.S. Pat. No. 4,872,210 that shows a wireless mail delivery alarm system for use in connection with a mailbox of American type in the form of an upwardly curved receptacle with a plane wall at the one end and at the other end a flap that is, at the lower end, hingedly connected to said receptacle. The transmitter unit shown in this disclosure is configured as a relatively large box-shaped unit that is mounted on the interior side of the mailbox flap. It is provided with a switch that registers when the flap is opened and as a consequence of this a radio signal is transmitted to a receiver located elsewhere. The transmitter unit shown in this patent is comparatively large and for this reason it will be in the way when mail and newspapers are delivered to the mailbox. Since the transmitter unit projects considerably from the mailbox flap there is also a risk that the transmitter unit is damaged when mail or newspapers are delivered or that it is exposed to vandalism.

Other examples of transmitter units for mail delivery alarm systems are known from eg U.S. Pat. No. 5,023,595 and U.S. Pat. No. 6,046,675. Each of these transmitter units consists of several parts that are connected by means of wires that, on the one hand, make the transmitter unit difficult to mount and, on the other, increases the risk of parts of the transmitter unit being destroyed. These transmitter units are also comparatively large and project relatively far and therefore, they may be in the way when mail or newspapers are delivered and, likewise, they are also very exposed to damage.

It is the object of the present invention to provide a mail delivery alarm system as described above, whereby the above-mentioned drawbacks are obviated.

This is obtained by configuring the above described mail delivery alarm system in such a manner that the transmitter unit is built into the mailbox or mail-slot flap.

Hereby it is obtained that the mailbox or mail-slot flap can be manufactured with an even exterior as opposed to the prior art mail delivery alarm systems, wherein the transmitter units are subsequently mounted on the mailbox or mail-slot flap and therefore project therefrom. Firstly, this means that the mail delivery alarm system does not contribute with any external, projecting parts on the mailbox or mail-slot flap, and mail and newspapers can thus be delivered without impediments through the mailbox or mail-slot flap. Secondly, this means that the mail delivery alarm system is far less exposed with regard to vandalism or other kinds of damage, the vital parts of the transmitter unit being concealed within the mailbox or mail-slot flap.

In order to achieve the longest possible transmission range for the transmitter unit, its antenna should be as large as possible, and therefore preferably it essentially follows the outer edge of the mailbox or mail-slot flap.

According to a particularly simple configuration of the mailbox or mail-slot flap, it comprises a front plate and a rear plate, and the transmitter unit is configured between the front plate and the rear plate.

In order to provide good transmission conditions for the radio signals of the transmitter unit, both the front plate and the rear plate can be manufactured from a plastics material. Hereby it is avoided that the mailbox or mail-slot flap in itself shields against the emitted radio signals.

According to a particular embodiment of the invention the front plate is made of metal, while the rear plate is made of a plastics material. This embodiment is of particular interest if the invention is used eg in connection with a mailbox of metal, or in case a particular design of the mailbox or mail-slot flap is desired. Albeit the front plate of metal shields against the radio signals of the transmitter unit, this is of no significant consequence to the functioning of the mail delivery alarm system, since radio signals are emitted only when the mailbox or mail-slot flap is opened.

The power supply of the transmitter unit preferably comprises one or more batteries. The transmitter unit using power only when emitting radio signals when the mailbox or mail-slot flap is activated, the power consumption is small and such batteries will last long.

According to a particular embodiment, in particular for use outdoors, the power supply of the transmitter unit may, however, comprise photovoltaic cells on or in the exterior surface of the mailbox or mail-slot flap. In this embodiment the power supply preferably comprises one or more rechargeable batteries that the photovoltaic cells are configured to recharge. In principle, by this embodiment it will never be necessary to replace the rechargeable battery.

The invention will now be described in further detail with reference to the drawings, wherein

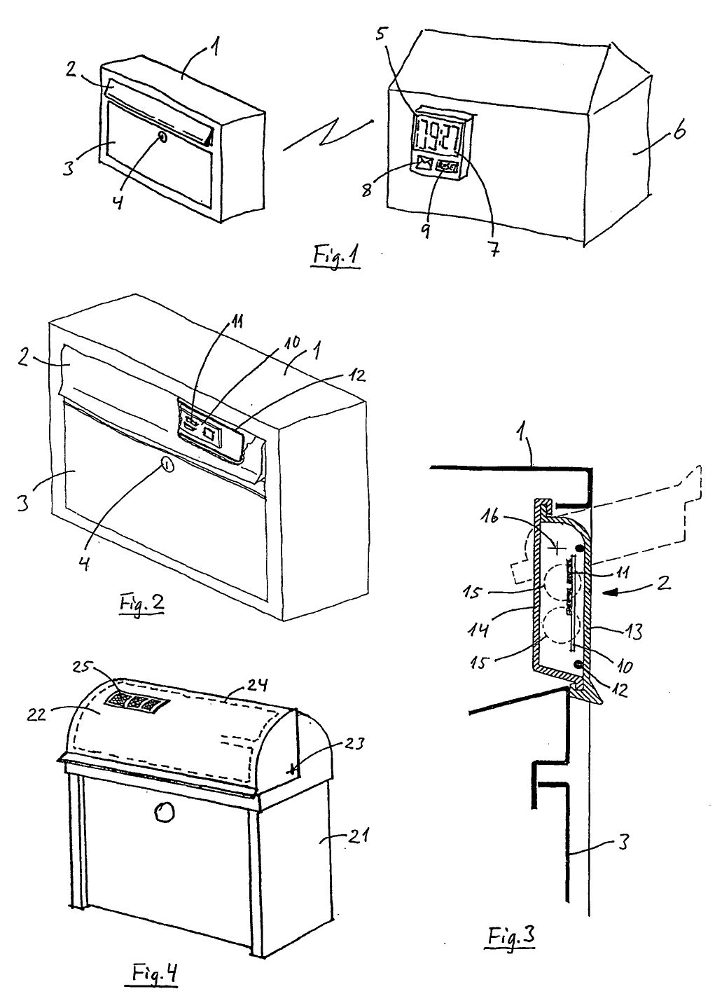

FIG. 1 is an explanatory sketch of a mail delivery alarm system and a transmitter unit according to the invention;

FIG. 2 is a partially sectional view of a first embodiment of a mailbox with a built-in transmitter unit in the flap;

FIG. 3 shows the mail box flap shown in FIG. 2 in a sectional view; and

FIG. 4 shows an alternative embodiment of a mailbox with a built-in transmitter unit in the flap.

FIG. 1 shows a radio-signal-based mail delivery alarm system in accordance with the invention. The mail delivery alarm system is, in the case shown, used in connection with a mailbox 1 with a mailbox flap 2 that can be tilted outwards or inwards for delivery of mail, newspapers, trade circulars, etc. The mailbox 1 is also provided with a large hatch 3 that can be opened by means of a key to the lock 4 when the mailbox 1 is emptied. The transmitter unit in the mail delivery alarm system is, in accordance with the invention, built into the mailbox flap 2 and is thus not visible in FIG. 1. The mail delivery alarm system also comprises a receiver unit 5 that is able to receive radio signals from the transmitter unit in a manner known per se.

The built-in transmitter unit is provided with a movement sensor and a transmitter that emits radio signals when the movement sensor registers a movement of the mailbox flap 2. The radio signals are captured by the receiver unit 5 located at a distance from the transmitter unit 1, it being located for instance as shown within a housing 6. The receiver housing 5 can be of any known type, but preferably it is configured with a clock, whereby the time when a radio signal was received from the transmitter unit is registered and shown in a display 7.

Preferably the receiver unit 5 is configured such that in normal circumstances the display 7 shows the current time of the day, but when mail, newspapers, trade circulars and the like are delivered to the mailbox 1 via the mailbox flap 2, whereby a radio signal is emitted from the transmitter unit, the receiver unit 5 registers the time when this signal was received and this is the time that is shown in the display 7, preferably alternating with another symbol, such as an envelope 8.

Thus, usually the user will see the current time of the day on the display 7 of the receiver unit 5, but in case something has been delivered to the mailbox 1, the user may—on the one hand—be notified to that effect by display of the envelope, and—on the other—he will be able to see when something was delivered to the mailbox 1. Also, the receiver unit 5 is provided with a reset button 9 that is activated after the mailbox 1 has been emptied, whereby the receiver unit 5 is zeroed and again shows the current time of the day, and the envelope 8 disappears.

FIG. 2 shows the mailbox 1 shown in FIG. 1 in an enlarged scale and with a partially cut-through mailbox flap 2, whereby the built-in transmitter unit is exposed. The mailbox 1 comprises, as already described, a mailbox flap 2 and a large hatch 3 for emptying the mailbox 1 by means of a key to the lock 4.

The front of the mailbox flap 2 is partially cut way, whereby parts of the transmitter unit are exposed. The transmitter unit comprises a circuit board 10 with electronic components 11, such as a movement sensor, a transmitter, an IC, etc. The concrete components do not constitute a part of the invention and a person skilled within the art will be able to readily point to such components. Besides, the transmitter unit comprises an antenna 12 that, in order to obtain the longest range possible for the radio signals, is located along the outer edge of the mailbox flap 2. Finally, the transmitter unit is provided with batteries (not shown) that can be replaced by means of a not shown opening in the mailbox flap 2.

The mailbox flap 2 is shown in a sectional view in FIG. 3, and it will appear therefrom that the mailbox flap 2 comprises a front plate 13 and a rear plate 14 with the transmitter unit located between the front plate 13 and the rear plate 14. Both the front plate 13 and the rear plate 14 are preferably made of a plastics material that does not shield against the radio signals transmitted from the transmitter unit. It will appear that the circuit board 10 with electronic components 11 is located between the front plate 13 and the rear plate 14, it being attached to one of the plates in a manner not specifically shown. Likewise, it will appear how the antenna 12 extends along the outer periphery of the mailbox flap 2 and thus provides the maximal transmitting conditions for achieving long range for the radio signals. The antenna 12 is preferably secured to the front plate 13, eg by gluing. Dotted lines outline two batteries 15 that serve as power supply to the transmitter unit.

FIG. 3 also shows that the mailbox flap 2 is hinged to the mailbox 1 about an axis 16. The mailbox flap 2 can thus be opened outwards, and can be tilted upwards to the position shown in dotted lines. The transmitter unit being built into the mailbox flap 2, there will be no projecting parts that may be in the way when mail or newspapers are delivered thereto.

FIG. 4 shows an alternative embodiment of a mailbox 21 with a built-in transmitter unit in the mailbox flap 22. This mailbox is provided with a large mailbox flap 22 that can be tilted about the axis 23. As outlined with a dotted line, such mailbox flap 22 can be provided with an antenna 24 that is considerably larger than the antenna 12 on the mailbox flap 2 shown in FIGS. 1-3. Hereby it is possible to obtain even longer ranges for the radio signals from the transmitter unit, which is advantageous in case the mailbox 21 is located far away from the receiver unit in the mail delivery alarm system.

Mailboxes 1, 21 can be manufactured from any material, such as plastics or metal, but preferably at least the mailbox flap 2, 22 is manufactured from plastics, so as to avoid it shielding against the emission of radio signals from the antenna 12, 24 of the transmitter unit. However, if the mailbox 1, 21 is made of metal, or for any other reason, the front plate 13 of the mailbox flap 2, 22 can be made of metal, while the rear plate 14 is still made of plastics or any other material that allows emission of radio signals from the transmitter unit. Albeit a front plate 13 of metal will shield against the radio signals of the transmitter unit, the rear plate 14 will still allow emission of radio signals, the radio signals being emitted when the mailbox flap 2, 22 is moved and hence opened.

The power consumption of the transmitter unit is comparatively low, since it consumes current only when radio signals are emitted. Therefore the longevity of the batteries is long, and it will be necessary to change batteries only years apart. In some cases batteries may be omitted altogether, eg in case there is sufficient sunlight for the transmitter unit to be supplied with power exclusively from photovoltaic cells 25 located in or on the mailbox flap exterior as shown in FIG. 4. Optionally the photovoltaic cells 25 can recharge a rechargeable battery, which—along with the transmitter unit—is built into the mailbox flap 22.

Finally, it should be mentioned that the invention is not limited to use in connection with mailboxes as shown in FIGS. 1-4; they may just as well lend themselves for use in connection with mail slots or other devices for delivery of mail and newspapers provided they feature a movable flap.

1. A radio-based signal mail delivery system comprising a transmitter unit provided in connection with a mailbox or mail-slot flap (2; 22) and a receiver unit (5) for being located at a distance from the transmitter unit and being able to receive a radio signal emitted by the transmitter unit, said transmitter unit comprising a movement sensor for detecting movement of the mailbox or mail-slot flap (2; 22) and a transmitter with power supply and antenna (12; 24) for emitting a radio signal in response to movement of the mailbox or mail-slot flap (2; 22) wherein the transmitter unit is built into the mailbox or mail-slot flat (2; 22).

2. A mail delivery alarm system according to claim 1, wherein the antenna (12; 24) of the transmitter unit essentially follows the outer edge of the mailbox or mail-slot flap (2; 22).

3. A mail delivery alarm system according to claim 1, wherein the mailbox of mail-slot flap (2) comprises a front plate (13) and a rear plate (14), and that the transmitter unit is configured between the front plate (13) and the rear plate (14).

4. A mail delivery alarm system according to claim 3, wherein the front plate (13) as well as the rear plate (14) are manufactured from a plastics material.

5. A mail delivery alarm system according to claim 3, wherein the front plate (13) is made of metal, whereas the rear plate (14) is made of a plastics material.

6. A mail delivery alarm system according to claim 1, wherein the power supply of the transmitter unit comprises one or more batteries (15).

7. A mail delivery alarm system according to claim 1, wherein the power supply of the transmitter unit comprises photovoltaic cells (25) on or in the exterior surface of the mailbox or mail-slot flap (22).

8. A mail delivery alarm system according to claim 7, wherein the power supply further comprises one or more rechargeable batteries, and that the photovoltaic cells (25) are configured for recharging these batteries.
